(19) United States
(12) Patent Application Publication
(10) Pub. No.: US 2013/0201335 A1
(43) Pub. Date: Aug. 8, 2013

(54) METHOD FOR VISUALIZING THE VICINITY OF A MOTOR VEHICLE

(71) Applicant: Audi AG, Ingolstadt (DE)

(72) Inventor: Patrick Heinemann, Kosching (DE)

(73) Assignee: Audi AG, Ingolstadt (DE)

(21) Appl. No.: 13/749,418

(22) Filed: Jan. 24, 2013

(30) Foreign Application Priority Data
Feb. 4, 2012 (DE) 10 2012 002 149.6

(51) Int. Cl. H04N 5/262

(52) U.S. Cl. CPC H04N 5/262
USPC 348/148

(57) ABSTRACT

A method for visualizing a vicinity of a motor vehicle, includes recording the vicinity of the motor vehicle with a camera, displaying the camera image on a display, and providing another detected road user in the camera image with a framing of a defined color, wherein the color is a function of a speed of the detected road user relative to the motor vehicle and is indicative of whether or not the speed of the detected road user is critical.

### CROSS-REFERENCES TO RELATED APPLICATIONS

This application claims the priority of German Patent Application, Ser. No. 10 2012 002 149.6, filed Feb. 4, 2012, pursuant to 35 U.S.C. 119(a)-(d) the disclosure of which is incorporated herein by reference.

### BACKGROUND OF THE INVENTION

The present invention relates to a method for visualizing the vicinity of a motor vehicle

The following discussion of related art is provided to assist the reader in understanding the advantages of the invention, and is not to be construed as an admission that this related art is prior art to this invention.

Different vehicle prototypes have already been presented by different manufacturers in which a conventional outside rear mirror or an inside rear mirror were replaced for a camera-monitor-system. For this, a camera which records the rear vicinity of the vehicle is placed at the position of the mirror. The image which is recorded by the camera is displayed on a display in the interior of the vehicle.

It would be desirable and advantageous to provide an improved method for visualizing the vicinity of a motor vehicle which better supports the driver to thereby facilitate the recognition of other road users.

### SUMMARY OF THE INVENTION

According to one aspect of the present invention, a method for visualizing a vicinity of a motor vehicle, comprising the steps of recording the vicinity of the motor vehicle with a camera; displaying the camera image on a display; and providing another detected road user, in particular another detected vehicle in the camera image with a framing of a defined color, wherein the color is a function of a speed of the detected road user relative to the motor vehicle and is indicative of whether or not the speed of the detected road user is critical.

The invention is based on the recognition that the interpretation of camera images is often complicated because a typical camera image contains a multitude of individual items of information which have to be processed quickly by the observer. This includes different features of the vicinity which often complicate the detection of other road users. Depending on the light conditions it can also be difficult to timely recognize vehicles with a particular color. This is further exacerbated by the fact that the speed or the relative speed of other road users cannot be detected by a single view at all. By the framing according to the invention of other road users on the other hand, relevant objects such as persons or other vehicles can be clearly marked, so that the driver knows that he has to direct his attention thereon. Such a framing is recognized particularly quickly because in a conventional camera image no such frames are visible. The displaying of a framing is therefore a particularly effective means to attract the attention of a user.

According to another advantageous feature of the present invention, the camera image can be subjected to image processing to extract a vehicle or a vehicle contour. In this way, relevant objects such as vehicles or other persons which are relevant for traffic safety can be distinguished from non relevant objects such as environmental features. Such image processing algorithms proceed in real time so that a recorded camera image is displayed immediately after the image processing, wherein as the case may be one or multiple road users are displayed provided with a framing.

In a refinement of the method according to the invention, differently colored framings are used for vehicles with different relative speeds. Using different colors allows display of the relative speed between the own vehicle and the other vehicles as additional information. The driver thus recognizes with one view by means of the color of the framing whether or not the other road users are a vehicle with a critical relative speed. The colored display of the framing thus increases the information content for the user of the displayed camera image.

According to another advantageous feature of the present invention, the relative speed and/or the distance of a detected vehicle can be displayed. These items of information allow the driver to better assess the other vehicle. In addition, items of information provided by a driver assist system can be displayed on the display. This includes lane change warnings and the like, which in this way can be perceived together with the camera image. Also, a warning or an emergency vehicle can be displayed. In the method according to the invention an inside rear mirror and/or an outside rear mirror of the motor vehicle can be used as display. As an alternative or in addition, a display arranged in the interior of the motor vehicle can be used for displaying the camera image. As the case may be, a different display can be used depending on the situation. For example, the inside rear mirror can be used as display in case of a driving vehicle. When parking or driving backward, the inside rear mirror or a display in the interior space of the vehicle can be used.

According to another advantageous feature of the present invention, a warning in form of a traffic sign or an icon can also be displayed in the camera image.

According to anther aspect of the present invention, a motor vehicle includes a camera for recording the vicinity of the motor vehicle and a display for displaying the recorded camera image.

The motor vehicle according to the invention is configured for implementing the described method and for displaying another detected road user, in particular another detected vehicle which is provided with a framing on the camera image.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a traffic situation when performing the method according to the invention; and

FIG. 2 shows the camera image displayed during the traffic situation of FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

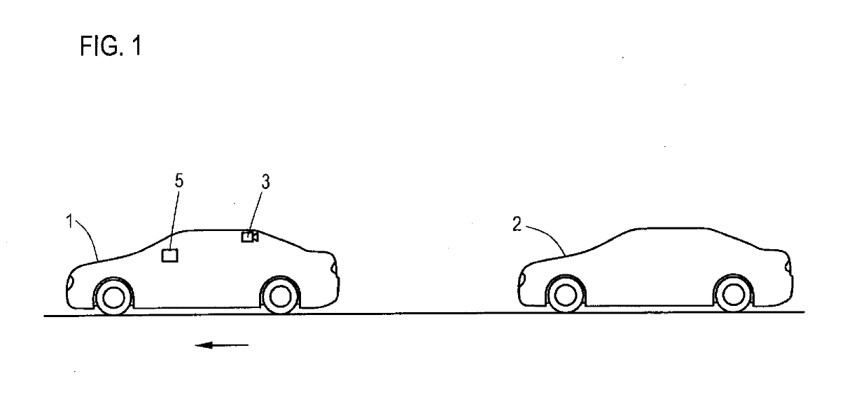

Turning now to the drawing, and in particular to FIG. 1, there is shown a first vehicle 1 and a second vehicle 2, which move in the direction of the arrow. The first vehicle 1 has a camera 3 with which the vicinity of the vehicle 1 is recorded. The camera 3 is arranged so that the rear vicinity is detected in the shown exemplary embodiment, correspondingly the second vehicle 2 is present in the camera image.

The camera image recorded by the camera 3 is subjected to an image processing to identify other road users. An image processing algorithm is provided for the purpose of identifying another vehicle or persons in the camera image. Vehicles are determined based on their contour or other characteristic features such as head lights or by means of a motion profile, by analyzing a sequence of vehicle images.

This image analysis allows calculating the relative speed of other road users, in particular the relative speed of following vehicles.

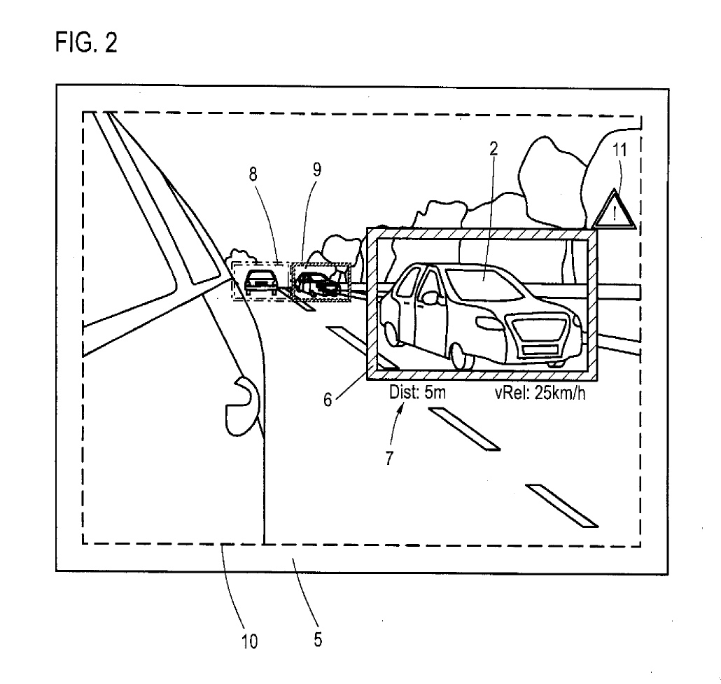

In the first vehicle 1, a schematically shown display 5 is present on which the camera image which was subjected to the image processing is shown. FIG. 2 schematically shows the display 5 with the camera image. The following vehicle 2 is provided with a framing 6 which has a defined color. In the shown exemplary embodiment, the framing 6 is shown in red, the color is replaced for a hatching in FIG. 2.

The color used for the framing corresponds to a defined relative speed, i.e., vehicles which move faster than the vehicle 1 are shown with a framing of a different color than vehicles which are moving slower than the vehicle 1.

In the shown exemplary embodiment, the color red is used when the other (second) vehicle 2 is in the blind spot. In FIG. 2, it can be recognized that the distance and the relative speed of the second vehicle 2 are shown as additional information 7 below the framing 6. In addition, a further vehicle with a green framing 8 is shown on the display, the green framing is used for vehicles which for reasons of traffic safety are not relevant, i.e., vehicles which move slower than the own vehicle. In addition, a vehicle with a yellow framing 9 is shown, yellow color is used as framing for vehicles whose relative speed is relevant. This includes vehicles which have a higher relative speed than the own vehicle 1 so that they approach slowly. In FIG. 2, the colored framings are replaced for different hatchings. The framings 8, 9 like the framing 6 are provided with additional items of information which indicate the distance and the relative speed. The colored representation allows the user to immediately recognize whether another road user poses a risk. He can thereby better assess other vehicles whereby the risk of a dangerous situation is decreased.

The camera image shown in FIG. 2 which is displayed on the display 5 is surrounded by a red framing 10, which is shown as dashed line in FIG. 2. By means of the red color the driver recognizes that the displayed camera image contains a warning in the sense of an “overall warning level”. In contrast, if the displayed camera image only contains vehicles with yellow or green framing the red framing 10 is omitted or it is replaced for a framing in yellow or green color.

In FIG. 2 it can be seen that in the region of the right upper corner of the red framing 6 a traffic sign 11 in the form of an icon is shown. This traffic sign 11 is perceived by the driver as warning enabling him to recognize an existing danger or an impending dangerous situation particularly quickly.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein.

What is claimed is:

1. A method for visualizing a vicinity of a motor vehicle, comprising the steps of:
recording the vicinity of the motor vehicle with a camera;
displaying the camera image on a display; and
providing another detected road user in the camera image with a framing of a defined color, wherein the color is a function of a speed of the detected road user relative to the motor vehicle and is indicative of whether or not the speed of the detected road user is critical.

2. The method of claim 1, wherein the other detected road user is another detected vehicle.

3. The method of claim 1, further comprising subjecting the camera image to an image processing to extract a vehicle or a vehicle contour.

4. The method of claim 2, wherein the framing is shown in red color when the speed of the another detected vehicle is critical, wherein the framing is shown in green color when the another detected vehicle is not relevant for reasons of traffic safety, and wherein the framing is shown in yellow color when the speed of the vehicle is relevant.

5. The method of claim 1, wherein the color of the framing is a function of a type of the vehicles.

6. The method of claim 1, wherein the speed of the other detected vehicle relative to the motor vehicle and/or a distance of the motor vehicle to the other detected vehicle is displayed on the display.

7. The method of claim 1, wherein a lane change warning provided by the driver assist system is displayed on the display.

8. The method of claim 1, wherein a warning regarding an emergency vehicle is displayed in the camera image.

9. The method of claim 1, wherein an inside rear mirror and/or an outside rear mirror of the motor vehicle is used as the display.

10. The method of claim 1, wherein a warning in form of a traffic sign or an icon is displayed in the camera image.

11. A motor vehicle comprising:
a camera for recording a vicinity of the motor vehicle; and
a display for displaying the recorded camera image, wherein the motor vehicle is configured for implementing the method of claim 1 and for displaying another detected road user, which was provided with a framing on the camera image.

12. The motor vehicle of claim 10, wherein the another detected road user is another detected vehicle
